(19) United States
(12) Patent Application Publication
(10) Pub. No.: US 2005/0078008 A1
(43) Pub. Date: Apr. 14, 2005

(54) Computer mouse and method for warning user to rest

(76) Inventor: Jung-Kai Cheng, Taipei (TW)

Correspondence Address: BIRCH STEWART KOLASCH & BIRCH, PO BOX 747, FALLS CHURCH, VA, 22040-0747, US

(21) Appl. No.: 10/671,838

(22) Filed: Sep. 29, 2003

(30) Foreign Application Priority Data
Jan. 13, 2003 (TW) 092100645

(51) Int. Cl. G08B 23/00

(52) U.S. Cl. 340/573.1; 340/309.16

(57) ABSTRACT

A computer mouse and a method for warning a user to rest during operation are provided. The computer mouse includes a first timer and a warning device. A first predetermined period of time is set in the computer mouse. The first timer monitors a period of time when the user operates the computer mouse. The warning device is enabled when the operating period is longer than the first predetermined period of time. The warning device is disabled when the user stops operating the computer mouse.

### CROSS REFERENCE TO RELATED APPLICATIONS

This application claims priority to Taiwan Patent Application No. 092100645 entitled “Device and Method for Alerting Mouse User to Rest”, filed Jan. 13, 2003.

### FIELD OF INVENTION

The present invention generally relates to an input device and a method for preventing a user from operating the input device over too long a period of time, and more particularly, to a computer mouse and a method for warning a user to rest during a prolonged use of the computer mouse.

### BACKGROUND OF THE INVENTION

As the technology continuously develops, people spend more and more time on computers. Particularly in recent years, the development of the electronic technology and the information technology has increased the popularity of computer games. Many users become immersed in computer games and jeopardize their health because of continuous use of computers. Therefore, it is desirable to develop a device compatible with a computer accessory and capable of warning users to take a break during operation of computers and its accessories.

Computers are usually equipped with a mouse to control the movement of the cursor. As users have spent more and more time on the computer, many of them have suffered injuries such as carpal tunnel syndrome, tendinitis and others caused by prolonged use of the computer mouse. Therefore, to provide a computer mouse capable of warning users to rest if the users operate it longer than a predetermined period of time is a resolution.

### SUMMARY OF THE INVENTION

One aspect of the present invention is to provide a method for warning a user to rest if the user operates a computer mouse longer than a predetermined period of time.

Another aspect of the present invention is to provide a computer mouse capable of warning a user to rest if the user operates the computer mouse longer than a predetermined period of time.

In a first embodiment, the present invention provides a method for warning a user to rest during operation of a computer mouse. The computer mouse includes a first timer and a warning device. The method includes steps of monitoring a period of operating the mouse by the first timer, enabling the warning device when the operating period is longer than a first predetermined period of time, and disabling the warning device when the user stops operating the mouse. The first predetermined period of time is, for example, set in the computer mouse.

In a second embodiment, a computer mouse includes a first timer, a second timer, and a warning device. When a user operates the computer mouse, the first timer monitors a period of operating the computer mouse. When the operating period is longer than a first predetermined period of time, the warning device is enabled. When the user stops operating the mouse, the second timer monitors a period of idling the computer mouse. When the idle period is longer than a second predetermined period of time, the first timer and the second timer are reset. If the user operates the mouse after an idle period shorter than the second predetermined period of time, the warning device is enabled. The first and second predetermined periods of time are, for example, set in the computer mouse.

In a third embodiment, a computer mouse includes a first timer, a second timer, and a warning device. When the user stops operating the mouse after a period of operating the mouse which is shorter than a first predetermined period of time, the second timer monitors an idle period of the mouse.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic block diagram of a computer mouse in one embodiment of the present invention;

FIG. 2 illustrates a flowchart of warning a user to rest during operation of a computer mouse in a first embodiment of the present invention;

FIG. 3 illustrates a flowchart of warning a user to rest during operation of a computer mouse in a second embodiment of the present invention; and

FIG. 4 illustrates a flowchart of warning a user to rest during operation of a computer mouse in a third embodiment of the present invention.

### DETAILED DESCRIPTION OF THE INVENTION

The present invention provides a method for warning a user to rest after a long period of time of operating a computer mouse, so as to prevent the user from jeopardizing his/her health because of prolonged use of the computer.

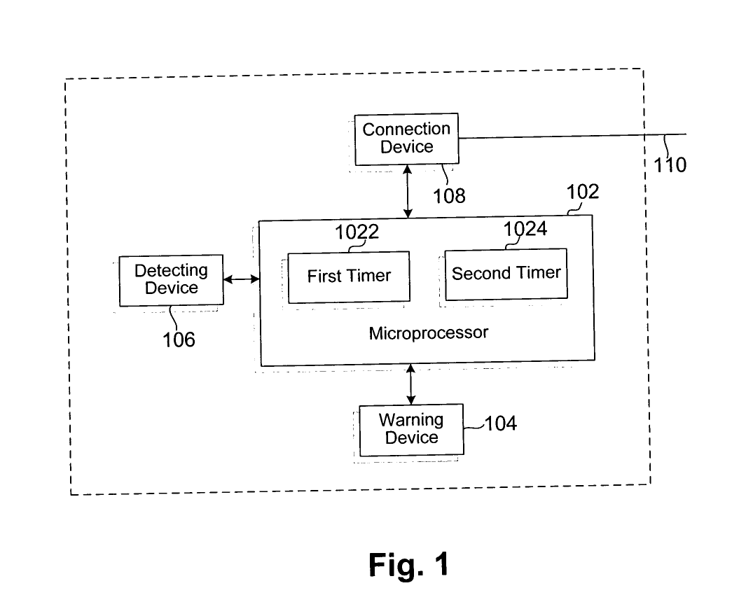

FIG. 1 illustrates a schematic block diagram of a computer mouse in one embodiment of the present invention. As shown in FIG. 1, the computer mouse 100 includes a microprocessor (or a controller) 102, a warning device 104, a detecting device 106, and a connection device 108. A first timer 1022 and a second timer 1024 are optionally built in the microprocessor 102 for monitoring a first period of time and a second period of time, respectively. The first period of time represents a period of operating the computer mouse 100, and the second period of time represents a period of idling the computer mouse 100. A first predetermined period of time and a second predetermined of time are optionally set in the microprocessor 102. The first predetermined period of time represents the period of allowing a user to continuously operate the mouse 100, and the second predetermined period of time represents the period of compelling a user to rest. For example, the first predetermined period of time can be set as 50 minutes, and the second predetermined period of time can be set as 10 minutes. In that case, a user is compelled to rest for 10 minutes after continuously operating the mouse 100 for 50 minutes.

Referring to FIG. 1 again, the warning device 104 controlled by the microprocessor 102 selectively provides a warning message to warn the user to rest. The warning message can be an audio message, and the warning device 104 is preferably a buzzer. Moreover, the warning device 104 can be a vibration motor so that the mouse 100 can vibrate to warn the user to stop operating the mouse. The detecting device 106 detects the movements of the mouse 100 and the actions of buttons on the mouse 100, and sends a corresponding signal to the microprocessor 102. The microprocessor 102 transfers the operating signals of the mouse 100 through the connection device 108 and the output port 110 to a computer (not shown). The connection device 108 can transfer signals according to different connection port of the computer, such as a PS/2 port, a serial port, or other connection ports as appropriate.

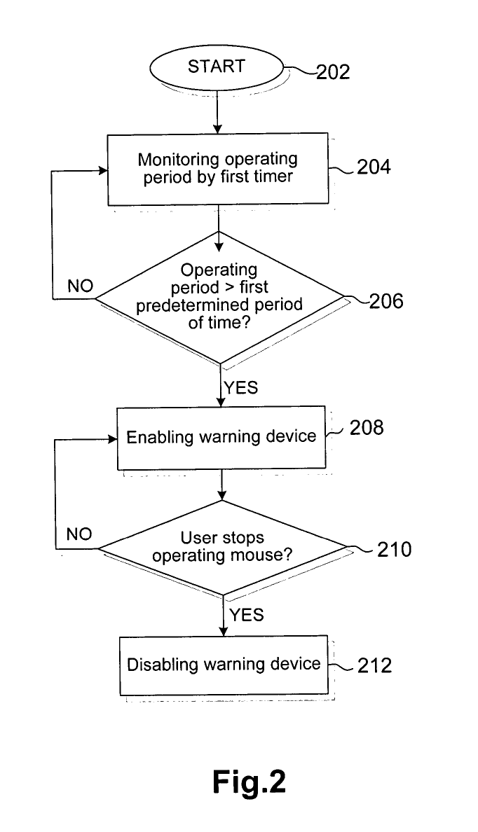

FIG. 2 illustrates a flowchart of warning a user to rest during operation of a computer mouse in a first embodiment of the present invention. The computer mouse includes a first timer and a warning device. When the user operates the mouse longer than a first predetermined period of time, the warning device is enabled until the user stops operating the mouse. The first predetermined period of time can be set in the computer mouse. The method begins with step 202. When the user operates the mouse, the first timer monitors a period of operating the mouse in step 204. In step 206, whether the operating period is longer than the first predetermined period of time is determined. If the operating period is determined shorter than the first predetermined period of time in step 206, the procedure goes back to step 204, and the first timer continuously monitors the operating period. If the operating period is determined longer than the first predetermined period of time in step 206, the warning device is enabled to warn the user in step 208. Whether the user stops operating the mouse is determined in step 210. If the user does not stop operating the mouse in step 210, the procedure goes back to step 208, and the warning device continuously sends a warning message to warn the user. If the user stops operating the mouse in step 210, the warning device is disabled in step 212.

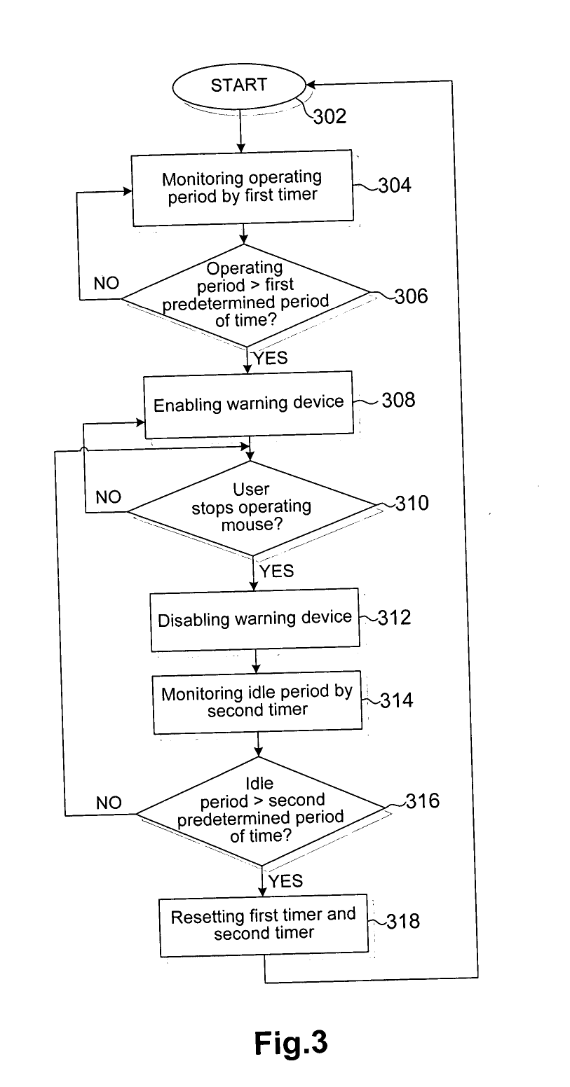

FIG. 3 illustrates a flowchart of warning a user to rest during operation of a computer mouse in a second embodiment of the present invention. The computer mouse includes a first timer, a second timer, and a warning device. When the user operates the mouse longer than a first predetermined period of time, the warning device is enabled until the user stops operating the mouse. In this embodiment, the second timer monitors a period of idling the computer mouse when the user stops operates it. When the user takes a rest longer than a second predetermined period of time, the user is allowed to operate the mouse again.

Referring to FIG. 3, the method begins with step 302. When the user operates the mouse, the first timer monitors a period of operating the mouse in step 304. In step 306, whether the operating period is longer than the first predetermined period of time is determined. If the operating period is determined shorter than the first predetermined period of time in step 306, the procedure goes back to step 304, and the first timer continuously monitors the operating period. When the operating period is determined longer than the first predetermined period of time in step 306, the warning device is enabled to warn the user in step 308. Whether the user stops operating the mouse is determined in step 310. If the user does not stop operating the mouse, the procedure goes back to step 308, and the warning device continuously sends a warning message to warn the user. When the user stops operating the mouse in step 310, the warning device is disabled in step 312.

As shown in step 314, the second timer monitors an idle period when the user stops operating the mouse. In step 316, whether the idle period is longer than the second predetermined period of time is determined. If the idle period is determined shorter than the second predetermined period of time, the procedure goes back to step 310, and whether the user operates the mouse is determined. If the idle period is determined longer than the second predetermined period of time, the first timer and the second timer are reset in step 318.

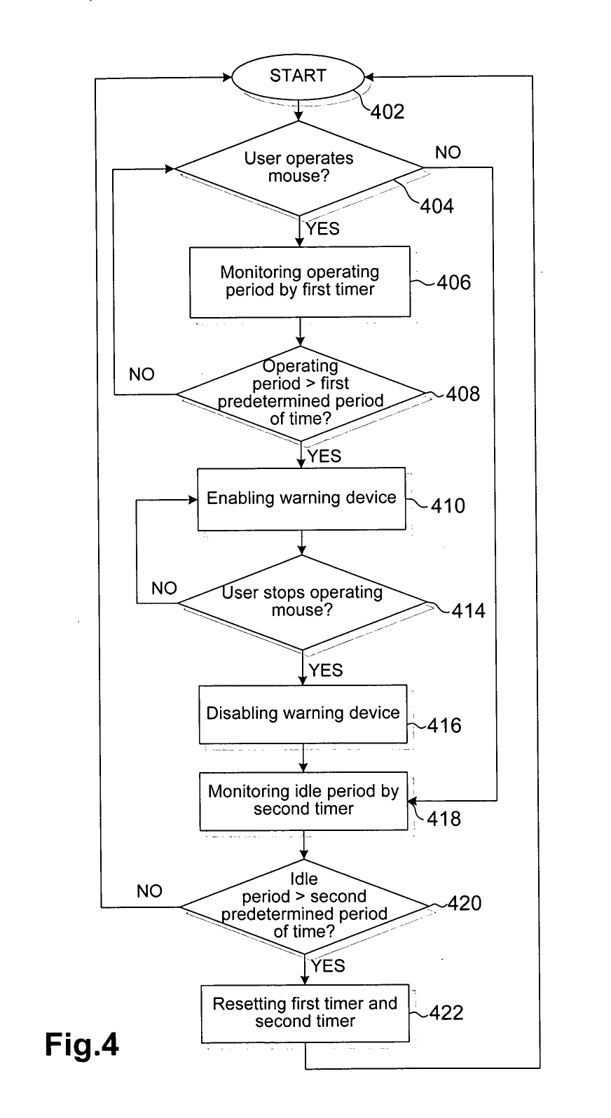

FIG. 4 illustrates a flowchart of warning a user to rest during operation of a computer mouse in a third embodiment of the present invention. The computer mouse includes a first timer, a second timer, and a warning device. When the user operates the mouse longer than a first predetermined period of time, the warning device is enabled until the user stops operating the mouse. When the user stops operates the mouse, the second timer monitors a period of idling the computer mouse. When the user takes a rest longer than a second predetermined period of time, the user is allowed to operate the mouse again. In this embodiment, when the user stops operating the mouse after an operating period shorter than the first predetermined period, the second timer monitors an idle period. If the idle period is longer than the second predetermined period of time, the first and the second timer are reset.

Referring to FIG. 4, the method begins with step 402. Whether the user operates the mouse is determined in step 404. If the user does not operate the mouse in step 404, the procedure goes to step 418, and the second timer monitors the idle period of the mouse. If the user operates the mouse in step 404, the procedure goes to step 406, and the first timer monitors a period of operating the mouse. In step 408, whether the operating period is longer than the first predetermined period of time is determined. If the operating period is determined shorter than the first predetermined period of time in step 408, the procedure goes back to step 404, and whether the user operates the mouse is determined. If the operating period is determined longer than the first predetermined period of time in step 408, the warning device is enabled to warn the user in step 410. In step 414, whether the user stops operating the mouse is determined. If the user does not stop operating the mouse in step 414, the procedure goes back to step 410, and the warning device continuously sends a warning message to warn the user. If the user stops operating the mouse in step 414, the warning device is disabled in step 416.

As shown in FIG. 4, if the user does not operate the mouse in step 404, or the warning device is disabled in step 416, the procedure goes to step 418 and the second timer monitors the idle period of the mouse. In step 420, whether the idle period is longer than the second predetermined period of time is determined. If the idle period is determined shorter than the second predetermined period of time, the procedure goes back to step 402 and repeats related steps described above. In other words, the warning device is disabled when the operating period is shorter than the first predetermined period of time even if the idle period is shorter than the second predetermined period of time. If the idle period is longer than the second predetermined period of time in step 420, the first timer and the second timer are reset in step 422.

Although specific embodiments have been illustrated and described, it will be obvious to those skilled in the art that various modifications may be made without departing from what is intended to be limited solely by the appended claims.

1. A method for warning a user to rest during operation of a computer mouse, said computer mouse comprising a first timer and a warning device, comprising:
monitoring a period of operating said computer mouse by said first timer;
enabling said warning device when said operating period is longer than a first predetermined period of time; and
disabling said warning device when the user stops operating said computer mouse.

2. The method of claim 1, said computer mouse further comprising a second timer, further comprising:
monitoring a period of idling said computer mouse by said second timer when the user stops operating said computer mouse; and
resetting said first timer and said second timer when said idle period is longer than a second predetermined period of time.

3. The method of claim 2, wherein said warning device is enabled when the user operates said computer mouse after said idle period, and said idle period is shorter than said second predetermined period.

4. The method of claim 2, wherein said second timer monitors said idle period of said computer mouse when the user stops operating said computer mouse after said operating period, and said operating period is shorter than said first predetermined period.

5. The method of claim 1, wherein said warning device sends an audio message to warn the user.

6. The method of claim 5, wherein said warning device comprises a buzzer.

7. The method of claim 1, wherein said warning device comprises a vibration motor.

8. A computer mouse capable of warning a user to rest during operation, comprising:
a first timer for monitoring a period of operating said computer mouse;
a warning device for selectively providing a warning message; and
a controller for controlling said warning device;
wherein said warning device is enabled when said operating period is longer than a first predetermined period of time, and said warning device is disabled when the user stops operating said computer mouse.

9. The computer mouse of claim 8, further comprising a second timer for monitoring a period of idling said computer mouse, wherein said second timer monitors said idle period when the user stops operating said computer mouse, and said controller resets said first timer and said second timer when said idle period is longer than a second predetermined period of time.

10. The computer mouse of claim 9, wherein said controller enables said warning device when the user operates said computer mouse after said idle period, and said idle period is shorter than said second predetermined period.

11. The computer mouse of claim 9, wherein said second timer monitors said idle period when the user stops operating said computer mouse after said operating period, and said operating period is shorter than said first predetermined period.

12. The computer mouse of claim 8, wherein said warning message comprises an audio message.

13. The computer mouse of claim 8, wherein said warning device comprises a buzzer.

14. The computer mouse of claim 8, wherein said warning device comprises a vibration motor.
